(19) United States
(12) Patent Application Publication
(10) Pub. No.: US 2010/0308543 A1
(43) Pub. Date: Dec. 9, 2010

(54) SEAL DEVICE

(76) Inventor: Yi-Chieh HUANG, Kachsiung City (TW)

Correspondence Address: Pearl Cohen Zedek Latzer, LLP, 1500 Broadway, 12th Floor, New York, NY, 10036, US

(21) Appl. No.: 12/649,482

(22) Filed: Dec. 30, 2009

(30) Foreign Application Priority Data
Jun. 5, 2009 (TW) 098118766

(51) Int. Cl. F16J 15/18

(52) U.S. Cl. 277/511

(57) ABSTRACT

A seal device includes a gland, a sleeve, a first sealing unit, a second sealing unit, a compression ring, a plurality of spring members, and at least one positioning member. The second sealing unit has an outer rotary ring surrounding and rotatable with the sleeve, an outer stationary ring contacting sealingly and slidingly the outer rotary ring around the sleeve, and a retainer abutting sealingly against the outer stationary ring oppositely of the outer rotary ring. The positioning member is disposed on the gland and extends into the outer stationary ring so as to prevent the outer stationary ring from rotation.

### BACKGROUND OF THE INVENTION

1. Field of the Invention

The invention relates to a seal device, more particularly to a seal device for a rotary shaft.

2. Description of the Related Art

A seal device is usually mounted on a rotary shaft of a mixing machine so as to prevent leakage of fluid stirred in a stirring tank of the mixing machine due to high pressure in the stirring tank.

Referring to FIGS. 1 and 2, a conventional seal device 1 disclosed in Taiwanese Utility Model No. M225697 includes a sleeve 11 sleeved on a rotary shaft 16, a gland 12 surrounding the sleeve 11, a stationary ring 13, a seal ring 10, a retaining ring 14, and a guiding member 15. The sleeve 11 includes a rotary ring 111 and a fixing collar 112. The gland 12 has a central hole 121 and a plurality of fluid passages 122 extending from an outer peripheral surface of the gland 12 to the central hole 121. The stationary ring 13 is disposed in the central hole 121, abuts against the rotary ring 111, and is provided with a plurality of engaging recesses 131. The seal ring 10 is disposed between the gland 12 and the stationary ring 13. The retaining ring 14 is retained in the central hole 121 of the gland 12, and is provided with a plurality of spring holes 141 for respectively receiving a plurality of springs 143, and a plurality of guiding grooves 142. The guiding member 15 surrounds the sleeve 11 between the stationary ring 13 and the retaining ring 14. The guiding member 15 is provided with a plurality of engaging blocks 151 correspondingly engaging the engaging recesses 131, and a plurality of guiding blocks 152 correspondingly engaging the guiding grooves 142 of the retaining ring 14. The engaging blocks 151 and the guiding blocks 152 project oppositely from the guiding member 15 and are aligned axially with each other.

Cooling fluid enters into the central hole 121 of the gland 12 via the fluid passages 122 so as to reduce the high temperature of the stationary ring 13 and the rotary ring 111 due to friction produced during operation. Furthermore, since the guiding blocks 152 of the guiding member 15 correspondingly engage the guiding grooves 142 of the retaining ring 14, the guiding member 15 can only move in an axial direction relative to the retaining ring 14. That is, the guiding member 15 does not rotate relative to the retaining ring 14 when it is urged by the springs 143. Therefore, the guiding member 15 can urge the stationary ring 13 to abut against the rotary ring 111 so as to form a sliding contact between the stationary ring 13 and the rotary ring 111 and to achieve a leakage proof effect.

However, the gap between the stationary ring 13 and the seal ring 10 of the seal device 1 may be clogged by particles, which in turn reduces the leakage proof effect.

Referring to FIGS. 3 and 4, a conventional dual seal device 2 disclosed in Taiwanese Utility Model No. M170449 is used when the fluid to be stirred by a mixing machine 31 is corrosive, evaporative, and/or toxic. The seal device 2 includes a sleeve 21, an inner rotary ring 22, an inner stationary ring 23, a gland 24, an outer stationary ring 25, an outer rotary ring 26, and a positioning ring 27. When the mixing machine 31 is operated, cooling fluid enters into a fluid passage 242 via an inlet 241 and exits from an outlet 243 so as to remove the heat produced by the rotation of a rotary shaft 32.

The seal device 2 is provided with a plurality of springs 28 between the inner stationary ring 23 and the outer stationary ring 25. In a normal state, the springs 28 urge the inner stationary ring 23 and the outer stationary ring 25 to respectively abut against the inner rotary ring 22 and the outer rotary ring 26 so as to achieve a dual leakage proof effect. When the pressure in a stirring tank of the mixing machine 31 is increased due to the stirring of the mixing machine 31, a collar 211 of the sleeve 21 is pushed by the pressure so that the inner rotary ring 22 and the inner stationary ring 23 are pressed by the collar 211 and the springs 28 to maintain the leakage proof effect.

However, the outer stationary ring 25 and the inner stationary ring 23 are merely urged by the springs 28, which may cause positional deviation of the springs 28.

### SUMMARY OF THE INVENTION

Therefore, an object of the present invention is to provide a seal device which has improved leakage proof effect, higher transmission stability, and extended service life.

Accordingly, the seal device for a rotary shaft of this invention includes at least a gland, a sleeve, a first sealing unit, a second sealing unit, a compression ring, a plurality of spring members, and at least one positioning member. The gland is adapted to surround the rotary shaft, and has a central hole and a fluid passage annularly surrounding the central hole. The sleeve is fitted in the central hole of the gland and has first and second ends which are opposite to each other. The first sealing unit is disposed proximate to the first end of the sleeve, and includes an inner rotary ring surrounding and rotatable with the sleeve, and an inner stationary ring contacting sealingly the inner rotary ring and provided with at least one positioning notch. The second sealing unit is disposed proximate to the second end of the sleeve, and has an outer rotary ring surrounding and rotatable with the sleeve, an outer stationary ring contacting sealingly the outer rotary ring, and a retainer abutting sealingly against the outer stationary ring oppositely of the outer rotary ring. The retainer has a plurality of spring holes and at least one engaging groove. The compression ring is disposed between the inner stationary ring and the retainer, and has a guiding block engaging the engaging groove of the retainer, and an engaging block engaging the positioning notch of the inner stationary ring. The guiding block and the engaging block project oppositely from the compression ring and are aligned axially with each other. Each of the spring members has one end extending into one of the spring holes and the other end urging the compression ring against the inner stationary ring. The positioning member is disposed on the gland and extends into the outer stationary ring so as to prevent the outer stationary ring from rotation.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded partly cutaway perspective view of a conventional seal device;

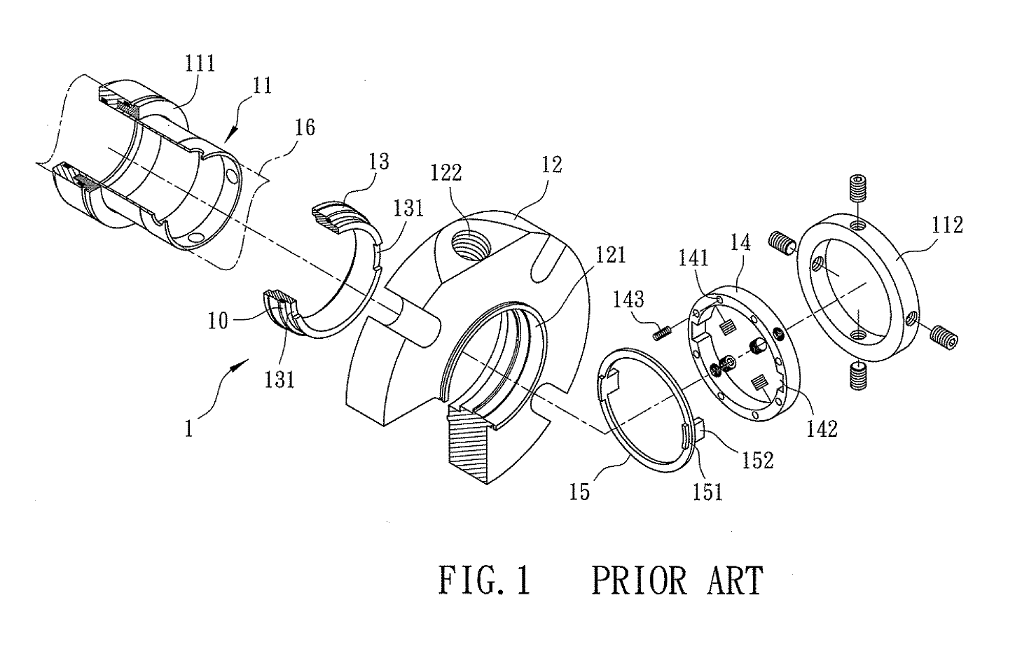

FIG. 2 is a sectional view of the conventional seal device;

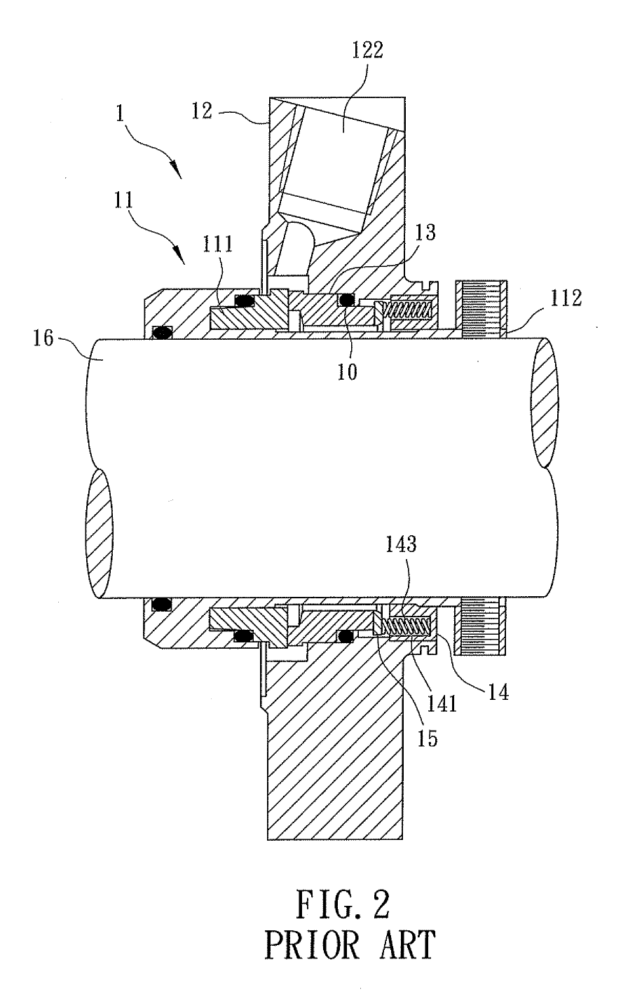

FIG. 3 is an exploded partly cutaway perspective view of a conventional dual seal device;

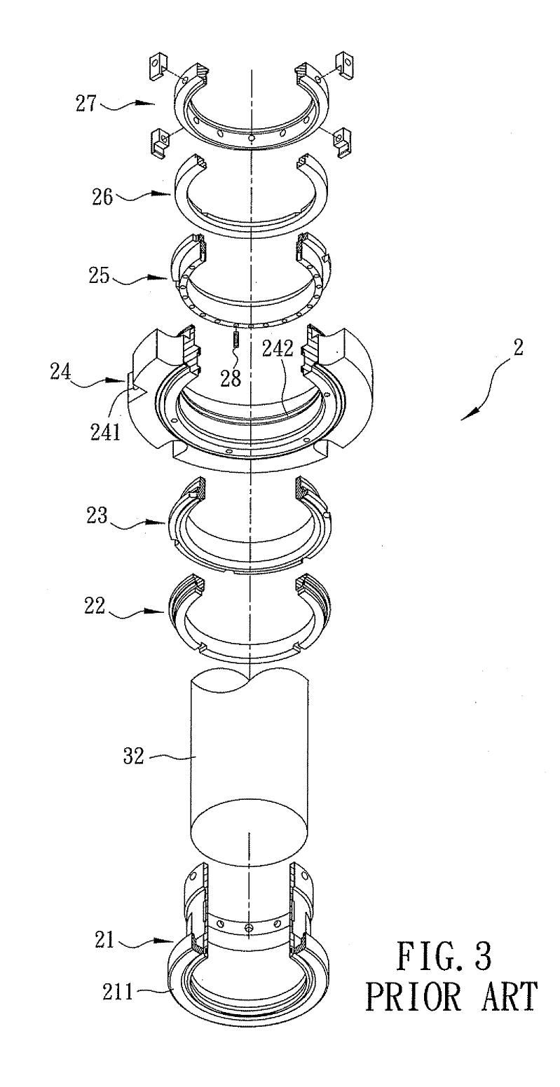

FIG. 4 is a sectional view of the dual seal device;

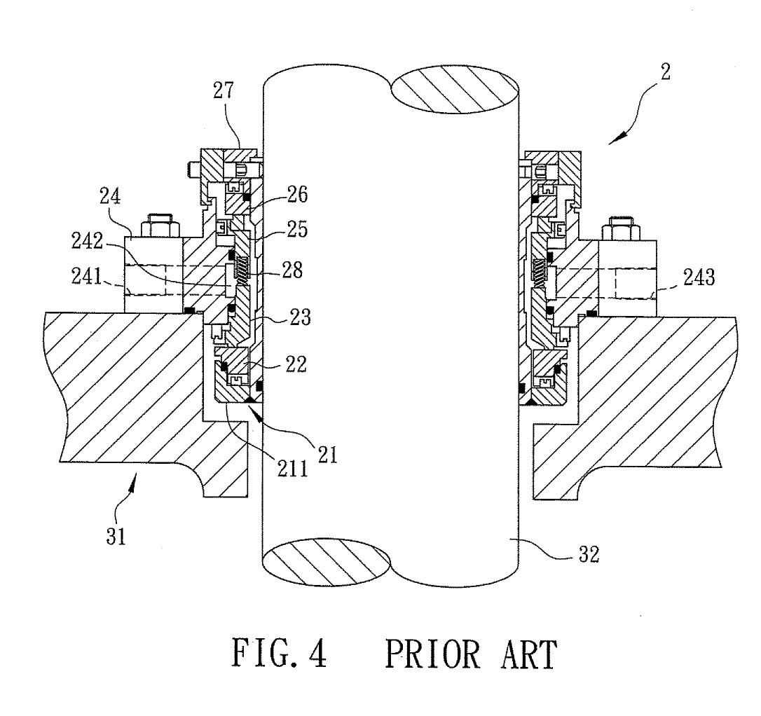

FIG. 5 is an exploded partly cutaway perspective view of a first preferred embodiment of a seal device according to this invention;

FIG. 6 is a sectional view of the first preferred embodiment;

FIG. 7 is another sectional view of the first preferred embodiment; and

FIG. 8 is a sectional view of a second preferred embodiment of a seal device according to this invention.

### DETAILED DESCRIPTION OF THE PREFERRED EMBODIMENTS

Before the present invention is described in greater detail, it should be noted that like elements are denoted by the same reference numerals throughout the disclosure.

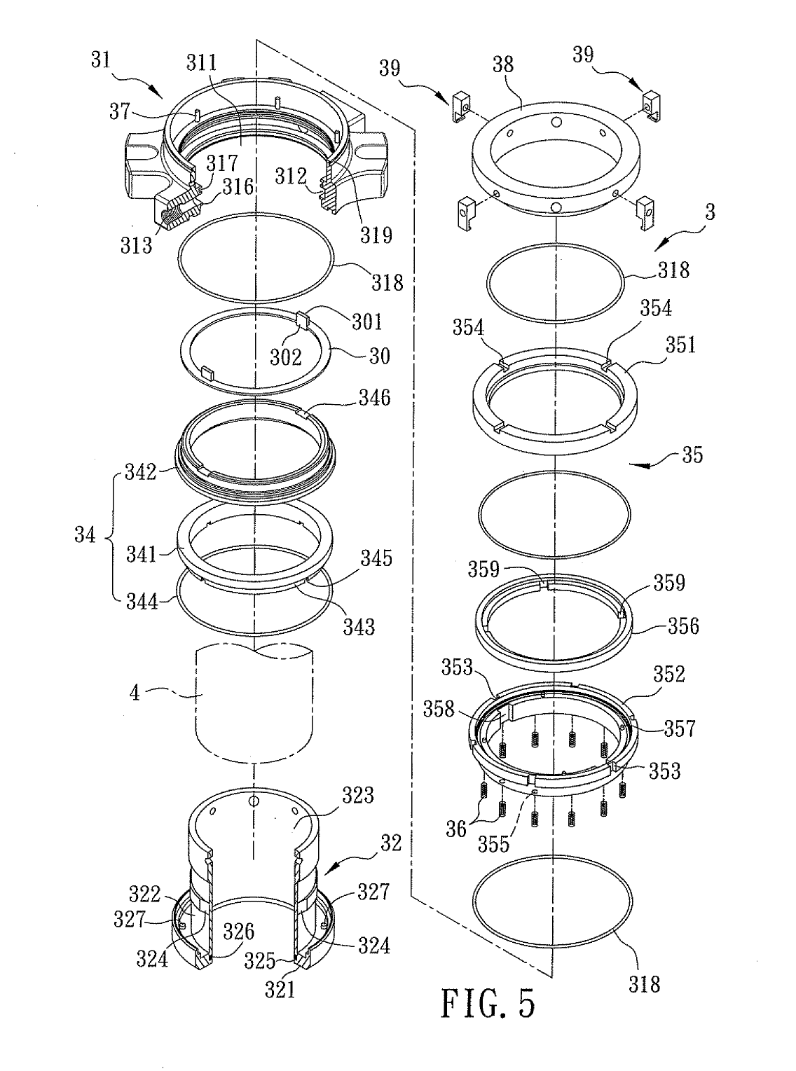

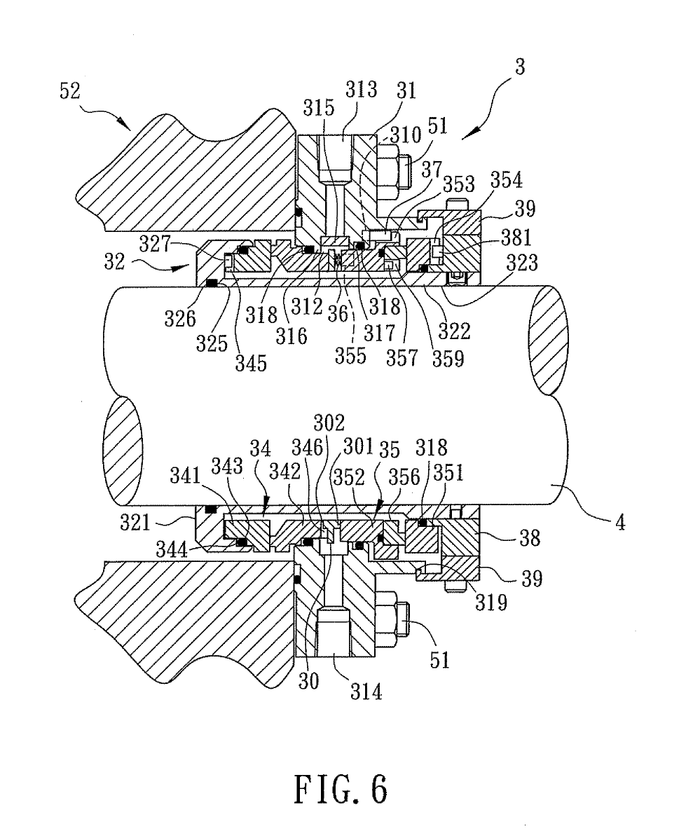

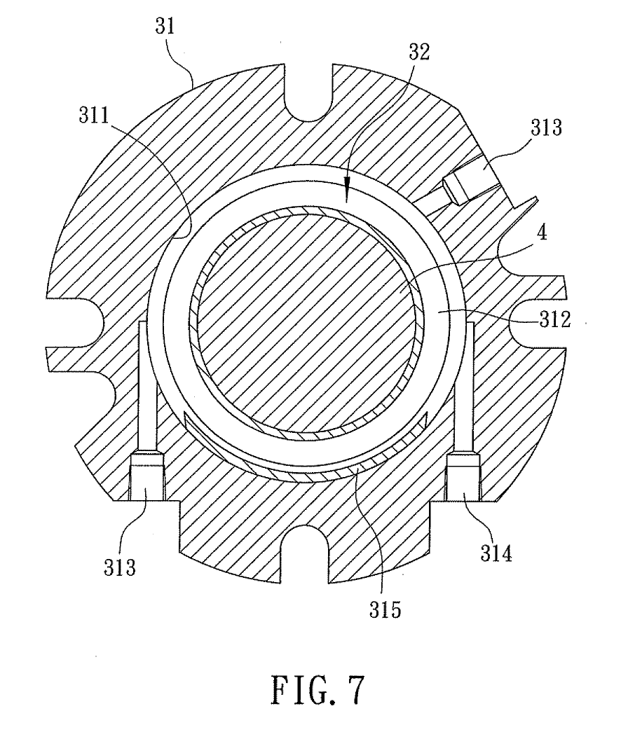

Referring to FIGS. 5, 6, and 7, the first preferred embodiment of a seal device 3 according to this invention is used for a rotary shaft 4 of a mixing machine 52, and includes a gland 31, a sleeve 32, a first sealing unit 34, a second sealing unit 35, a compression ring 30, a plurality of spring members 36, a plurality of positioning members 37, a collar 38, and a plurality of setting plates 39. It should be noted that two or more glands 31 can be used in series, if necessary.

The gland 31 is installed on the mixing machine and adapted to surround the rotary shaft 4, and has a central hole 311, a fluid passage 312 annularly surrounding the central hole 311, two inlets 313, an outlet 314 fluidly communicated with the fluid passage 312, and a flow-guiding plate 315 extending along the fluid passage 312 between the outlet 314 and one of the inlets 313. Preferably, the flow-guiding plate 315 is disposed proximate to one of the inlets 313 or proximate to the outlet 314. The flow-guiding plate 315 is inclined so as to guide cooling fluid to flow smoothly in the fluid passage 312. Additionally, the gland 31 is provided with an annular flange 316 and an annular groove 317 annularly surrounding the central hole 311. The fluid passage 312 is formed between the annular flange 316 and the annular groove 317. The gland 31 further includes an annular engaging groove 319 at an outer peripheral surface of the gland 31, and a plurality of position holes 310 extending axially in the gland 31.

The sleeve 32 is fitted in and extends through the central hole 311 of the gland 31, and has first and second ends opposite to each other. The sleeve 32 includes a cover 321 projecting outwardly from the first end of the sleeve 32, a surrounding body 322 extending upwardly from the cover 321 and passing through the central hole 311 of the gland 31, and a plurality of conveying portions 324 provided on an outer periphery of the sleeve 32 and angularly spaced from each other. In the preferred embodiment, each of the conveying portions 324 is configured in a form of a groove. The surrounding body 322 defines a passage 323 for permitting the rotary shaft 4 to pass therethrough. The inner peripheral surface of the surrounding body 322 is provided with an annular groove 325 proximate to the first end of the sleeve 32. A secondary ring 326 is disposed in the annular groove 325 so as to prevent the leakage of fluid from a gap between the rotary shaft 4 and the sleeve 32. The cover 321 has a plurality of axially projecting studs 327.

The first sealing unit 34 is disposed proximate to the first end of the sleeve 32, and includes an inner rotary ring 341 surrounding and rotatable with the sleeve 32, and an inner stationary ring 342 contacting sealingly the inner rotary ring 341 and provided with a plurality of positioning notches 346. The inner rotary ring 341 has an outer annular stepped surface 343. A secondary ring 344 is disposed on the stepped surface 343. The inner rotary ring 341 is received in the cover 321, and is provided with a plurality of recesses 345 respectively engaging the axially projecting studs 327. Furthermore, a secondary ring 318 is disposed between the inner stationary ring 342 and the annular flange 316.

The second sealing unit 35 is disposed proximate to the second end of the sleeve 32, and has an outer rotary ring 351 surrounding and rotatable with the sleeve 32, an outer stationary ring 356 contacting sealingly the outer rotary ring 351, and a retainer 352 abutting sealingly against the outer stationary ring 356 oppositely of the outer rotary ring 351. The outer rotary ring 351 is provided with a plurality of recesses 354 distal from the outer stationary ring 356. The outer stationary ring 356 has an inner peripheral surface formed with a plurality of recesses 359. The retainer 352 has an outer peripheral surface formed with a plurality of limiting grooves 353 that extend axially in the outer peripheral surface. Additionally, the retainer 352 has a plurality of spring holes 355 facing toward the inner stationary ring 342, a plurality of engaging grooves 358 formed at an inner peripheral surface thereof, and a plurality of engaging projections 357 protruding axially and respectively into the recesses 359 of the outer stationary ring 356.

The compression ring 30 is disposed between the inner stationary ring 342 and the retainer 352, and has a guiding block 301 engaging the engaging groove 358 of the retainer 352, and an engaging block 302 engaging the positioning notch 346 of the inner stationary ring 342. The guiding block 301 and the engaging block 302 project oppositely from the compression ring 30 and are aligned axially with each other.

The spring members 36 urge the first sealing unit 34 and the second sealing unit 35 so as to produce a dual sealing effect. Each of the spring members 36 has one end extending into one of the spring holes 355 of the retainer 352, and the other end urging the compression ring 30 against the inner stationary ring 342.

The positioning members 37 are disposed on the gland 31 and extend into the retainer 352 so as to prevent the outer stationary ring 356 and the retainer 352 from rotation. Each of the positioning members 37 has one end portion that extends movably into a corresponding one of the limiting grooves 353 and that is limited from rotation by the corresponding one of the limiting grooves 353. In this preferred embodiment, each of the positioning members 37 is a pin fitted in a corresponding one of the position holes 310. Alternatively, each of the positioning members 37 can be a bolt threadedly engaged in a corresponding one of the position holes 310.

The collar 38 is connected to the second end of the sleeve 32, and has a plurality of studs 381 respectively engaged in the recesses 354 of the outer rotary ring 351. Each of the setting plates 39 has one end portion connected to the collar 38 and the other end portion engaging the annular engaging groove 319 of the gland 31. The setting plates 39 are connected to the collar 38 through set screws. The setting plates 39 and the set screws are removed prior to the operation of the mixing machine 52.

In use, the gland 31 of the seal device 3 is engaged to the mixing machine 52 using bolts 51. Since the sleeve 32 is sleeved on and coupled to the rotary shaft 4, the sleeve 32, the inner rotary ring 341, and the outer rotary ring 351 are rotated simultaneously with the rotary shaft 4. The pressure produced in a stirring tank of the mixing machine 52 pushes the cover 321 of the sleeve 32, which in turn urges the inner rotary ring 341, the inner stationary ring 342, the spring members 36, and the compression ring 30. Since the guiding block 301 of the compression ring 30 engages and is slidable relative to the engaging groove 358 of the retainer 352, the reaction force formed due to the pressure can be diminished by the spring members 36 so as to maintain the leakage proof effect. Furthermore, each of the positioning members 37 has one end portion that extends movably into a corresponding one of the limiting grooves 353 and that is limited from rotation by the corresponding one of the limiting grooves 353 so as to prevent the outer stationary ring 356 and the retainer 352 from rotation.

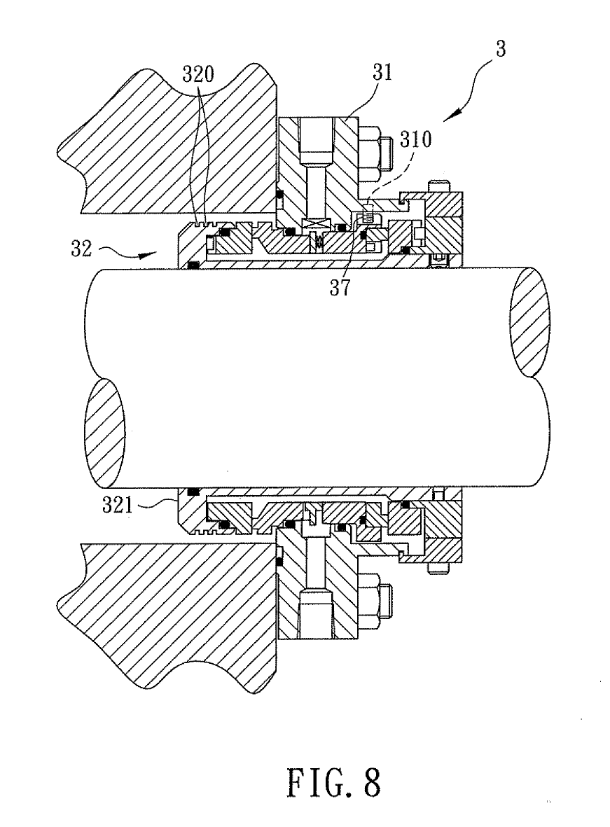

Referring to FIG. 8, the second preferred embodiment of a seal device 3 according to this invention is substantially identical to the first preferred embodiment except that the position holes 310 of the gland 31 extend radially in the gland 31 and the positioning members 37 are bolts threadedly and correspondingly engaged in the position holes 310. Alternatively, the positioning members 37 can be pins correspondingly fitted in the position holes 310. Furthermore, the cover 321 of the sleeve 32 has an outer peripheral surface formed with a spiral groove 320.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A seal device for a rotary shaft, comprising:
at least a gland adapted to surround the rotary shaft, and having a central hole, and a fluid passage annularly surrounding said central hole;
a sleeve fitted in said central hole of said gland and having first and second ends which are opposite to each other;
a first sealing unit disposed proximate to said first end of said sleeve, and including an inner rotary ring surrounding and rotatable with said sleeve, and an inner stationary ring contacting sealingly said inner rotary ring and provided with at least one positioning notch;
a second sealing unit disposed proximate to said second end of said sleeve, and having an outer rotary ring surrounding and rotatable with said sleeve, an outer stationary ring contacting sealingly said outer rotary ring, and a retainer abutting sealingly against said outer stationary ring oppositely of said outer rotary ring, said retainer having at least one engaging groove;
a compression ring disposed between said inner stationary ring and said retainer, and having a guiding block engaging said engaging groove of said retainer, and an engaging block engaging said positioning notch of said inner stationary ring, said guiding block and said engaging block projecting oppositely from said compression ring and being aligned axially with each other;
a plurality of spring members disposed between said compression ring and said retainer; and
at least one positioning member disposed on said gland and extending into said retainer so as to prevent said outer stationary ring and said retainer from rotation.

2. The seal device as claimed in claim 1, wherein said gland further includes at least one inlet and an outlet fluidly communicated with said fluid passage.

3. The seal device as claimed in claim 2, wherein said gland further includes a flow-guiding plate extending along said fluid passage and proximate to said inlet.

4. The seal device as claimed in claim 2, wherein said gland further includes a flow-guiding plate extending along said fluid passage and proximate to said outlet.

5. The seal device as claimed in claim 1, wherein said sleeve further includes a plurality of conveying portions provided on an outer periphery of said sleeve and angularly spaced from each other.

6. The seal device as claimed in claim 5, wherein each of said conveying portions is configured in a form of a groove.

7. The seal device as claimed in claim 1, wherein said retainer has an outer peripheral surface formed with at least one limiting groove that extends axially in said outer peripheral surface, said positioning member having one end portion that extends movably into said limiting groove and that is limited from rotation by said limiting groove.

8. The seal device as claimed in claim 1, said gland further includes an annular flange and an annular groove annularly surrounding said central hole, said fluid passage being formed between said annular flange and said annular groove.

9. The seal device as claimed in claim 1, wherein said gland further includes a position hole extending axially in said gland.

10. The seal device as claimed in claim 1, wherein said gland further includes a position hole extending radially in said gland.

11. The seal device as claimed in claim 9, wherein said positioning member is a pin fitted in said position hole.

12. The seal device as claimed in claim 10, wherein said positioning member is a pin fitted in said position hole.

13. The seal device as claimed in claim 9, wherein said positioning member is a bolt threadedly engaged in said position hole.

14. The seal device as claimed in claim 10, wherein said positioning member is a bolt threadedly engaged in said position hole.

15. The seal device as claimed in claim 1, wherein said sleeve further includes a cover projecting outwardly from said first end of said sleeve and receiving said inner rotary ring, said cover having a plurality of axially projecting studs, said inner rotary ring being provided with a plurality of recesses respectively engaging said axially projecting studs.

16. The seal device as claimed in claim 15, wherein said cover of said sleeve has an outer peripheral surface formed with a spiral groove.

17. The seal device as claimed in claim 1, further comprising a collar fixed to said second end of said sleeve, said outer rotary ring being provided with a plurality of recesses distal from said outer stationary ring, said collar having a plurality of studs respectively engaged in said recesses of said outer rotary ring.

18. The seal device as claimed in claim 1, wherein said outer stationary ring is provided with a plurality of recesses, and said retainer includes a plurality of engaging projections protruding axially and respectively into said recesses of said outer stationary ring.

19. The seal device as claimed in claim 1, wherein said retainer has a plurality of spring holes, each of said spring members having one end extending into one of said spring holes and the other end urging said compression ring against said inner stationary ring.
